(19) United States
(12) Patent Application Publication
(10) Pub. No.: US 2014/0359417 A1
(43) Pub. Date: Dec. 4, 2014

(54) SYSTEMS AND METHODS FOR GRAPHICALLY MODULATING STRUCTURED DATA

(71) Applicant: OMER BAR-ON, KFAR-SABA (IL)

(72) Inventor: OMER BAR-ON, KFAR-SABA (IL)

(21) Appl. No.: 13/910,099

(22) Filed: Jun. 4, 2013

(51) Int. Cl. G06F 17/24

(52) U.S. Cl. CPC G06F 17/246
USPC 715/212

(57) ABSTRACT

Generally described, embodiments of the present invention provide the ability to graphically modulating structured data, in a spreadsheet application and other applications, by applying any kind of cell formatting properties or design features to a given cell. Graphical modulation is determined based on formulae characteristics. In embodiments of the present invention, formula characteristics include various types of formula contained in a given cell. Formula types include, but are not limited to the following formula types, “workbook linked formula”, “sheet linked formula”, “cell linked formula”, “sensitivity formula”, “array formula”, “retrieving formula”, “calculative formula”, “computed input formula”, and “input formula”. In other embodiments of the present invention, formula characteristics include calculation complexity levels in formula contained in a given cell. In another embodiment of the present invention, applying graphical modulations can be presented on a surface display, above the cells surface, in the form of layers, for each formula characteristic.

### TECHNICAL FIELD

In general, the present invention pertains to the arts of systems and methods for graphically modulating structured data. In particular, the invention relates to systems and methods for graphically modulating structured data in an electronic spreadsheet application (e.g. Microsoft Excel or Lotus 1-2-3) by visualization of data in a spreadsheet according to the cells formulae characteristics and contents, and an aid tool particularly dedicated therefor.

### BACKGROUND ART

It is believed that the pertinent state-of-the-art is represented by: US patents Ser. No. 7770100, 8286072, 7627812, 6460059, 7933862, 7634717, 7533340, 6828988, 7984371, 6057837, 7644370, 7650576, 6256649, 7451397, 6961898, 7647551, 6640234, 7117430, 7415481, 8015481, 7991804, 7792847, 7698287, 5598519 and 6138130; as well as US patent applications Ser. No. 20060080594, 20060080595, 20070050700 and 20070074112.

### BACKGROUND OF THE INVENTION

Electronic spreadsheet applications, such as Microsoft Excel© or Lotus 1-2-3© organize information into a matrix of columns and rows. Each column within a row is referred to as a cell. Each cell of an electronic spreadsheet is able to store a data input or a formula that may include references to other cells, to calculate a desired result. To ease computation, electronic spreadsheets include built-in functions that perform most standard mathematical operations and may also include user-defined functions. Spreadsheet applications, often present a tremendous amount of data to a user. Typically spreadsheets may contain hundreds of formulae that perform various operations on data. Spreadsheets may also include functionality to apply a variety of formatting options to a cell. Exemplary formatting options include: font face, colour, size and style; border style and colour; background colour; conditional formatting rules; etc. Formatting may usually be accomplished per cell or per a group of cells. Thus, a typical spreadsheet may include a variety of different formats to any given cell.

While spreadsheet users can build complex formulae and analyze a wide range of data, it is difficult for users to memorize every cell formula. Even in spreadsheets that are used frequently, it is difficult for users to remember the types of most of the formulae. This problem is also compounded by the fact the formulae are often not clearly viewed all at once, since they can be spread throughout disorderly cells locations and can be found in numerous separate worksheets and spreadsheet files. Moreover, when a user looks over a spreadsheet the user is presented with cell values, but is not presented with any reference regarding the formulae characteristics that generate these values. Therefore, inquiry of spreadsheet formulae may consume the user's time and effort. For example, if a user wishes to examine a familiar spreadsheet, but does not remember the distribution of formulae within the spreadsheet, or especially if a user wishes to examine an unfamiliar spreadsheet, the user must thoroughly investigate the formulae in the spreadsheet cells. This process can become very tedious when a user examines a large number of formulae. These drawbacks slow down the process of investigating the spreadsheet formulae and often cause users to lengthen the completion of their task.

Spreadsheets cells often contain user errors. It is common for users to make mistakes when creating spreadsheets and difficult for users to recognize and correct these mistakes, because many spreadsheet errors are not easily identifiable. For example, some errors reside in a cell that cannot be noticed easily, such as input value or formula contains only calculated input values (referred to herein as “computed input formula”) that accidentally entered instead of “calculative formula”, or such as “cell linked formula” that accidentally entered instead of “workbook linked formula”. Another example is a short formula entered instead of a long and complex formula for testing the calculation result that may be forgotten in the cell. These errors are referred to as defective input errors or defective calculation errors. As such, these errors do not generate an error flag in conventional spreadsheet applications, but can cause serious flaws in the spreadsheet's calculated results. In addition a widespread of spreadsheet errors may cause users to question the validity of results in spreadsheets, and the use of a spreadsheet as a platform for critical calculations. Furthermore, when users look over a spreadsheet in normal mode of view, the only things they can see, regarding information about the spreadsheet cells, are the cells values and designs. This partial spreadsheet picture, which does not reflect information about the cells formulae, that generates those values, reduces the level of confidence accorded to the calculations presented in the spreadsheet.

These problems are exacerbated in a large organization that may have a large group of users, using complex collections of spreadsheet files, in which one error can result in a chain of calculation errors and have a material effect on the reports of the organization. A combination of multiple users and numerous spreadsheet files, in a large organization, is also likely to increase the possibility of users to examine unfamiliar spreadsheets on a regular basis, thus intensifies these problems. Additionally, there is an insufficient use in a shared language for spreadsheet applications in many organizations. When every user is using its own preferred formatting rules, misunderstandings are liable to arise in regard to the significance ascribed by a user to each format. There are also organizations that do not implement any uniform spreadsheet language at all.

In conventional spreadsheet applications, users that want to observe the cells formulae, have two main, inefficient, approaches available to them. One approach is to select a cell in order to view its formula in the formula bar (or double click the cell in order to view the formula within the cell itself). This operation can only be carried out for one cell at a time, so it is quite inefficient; Or to switch to show formulae mode in order to present the formula of each cell rather than the value. This option suffers from a drawback because while the value itself usually takes up a relatively small amount of space, the formula can be far longer than its resulting value, which means that this mode often shows only the beginning of each formula, and even that is at the expense of showing the values. Another approach to providing a user with information about the cell formula, in some conventional spreadsheet applications, are the watch window or the evaluate formula tool or other similar tools that provides a display of the formula in a separate window. However, these processes can be tedious and difficult to use, because they involves working with a dialog box separate from the spreadsheet itself.

Data visualization techniques enable users to scan and quickly comprehend large quantities of information. Such techniques may also aid in alerting users to anomalies and errors. Visualization tools can transform data into meaningful colours, and patterns. Data visualization has also included the use of conditional formatting in spreadsheets. In order to distill a large volume of information, a conditional formatting capability, provided in conventional spreadsheet applications, enables users to modify the look of cells, by changing the appearance of individual spreadsheet cells based on the value of the cell. However, current conditional formatting functionality is limited to formats conditioned upon values. Such formatting should not be restricted to a set of formats conditions that based solely on cells values. Typically, if the user wishes to automatically change the appearance of individual cells based on formula characteristics of the cell, the user must author a complex of conditional formatting rules by formula and also write complex customized user-defined functions that return true or false, a task that is even beyond the advance spreadsheet user. This limitation prevents data visualization techniques from fully realizing their potential as analysis and investigative tools. Some products offer ability for creating formatting conditions with regarding to the cell formula, but they are based on an easy implementation technique rather than on a fulfillment of complete logical method. Additionally, they are limited to just a few unsettled types of formulae, and do not come close to covering the full range of formulae types that advanced users wish to apply to their data, such as “workbook linked formula”, “sheet linked formula”, “cell linked formula”, “sensitivity formula”, “array formula”, “retrieving formula”, “calculative formula”, “computed input formula”, and “input formula”, etc. or other formula characteristics, such as calculation complexity. Thus, a significant drawback found in prior spreadsheet applications is the inability to vary cell formats, according to the formulae types and characteristics.

Therefore, there is a need in the art for the ability to graphically modulating spreadsheet cells according to formulae characteristics and the types of formulae, which are based on a complete logical method. The present invention proposes a means of assisting the user with analyzing and investigating spreadsheets by providing a graphical representation of the formulae contained in the cells. It is with respect to these and other considerations that the present invention has been made.

### SUMMARY OF THE INVENTION

This summary is provided to introduce a selection of concepts in a simplified form that are further described below in the detailed disclosure of embodiments. This summary is not intended to identify key features or essential features of the claimed subject matter, nor is it intended to be used as an aid in determining the scope of the claimed subject matter.

The present invention fulfills the above-described needs in the art by providing applications which display structured data, in particularly electronic spreadsheet application, with functionality for automatically graphically modulating cells, where each cell is visualized differently according to its formula characteristics, mainly formula type and formula calculation complexity, but also based on cell content. Graphically modulating of cells can be applied by any kind of cell formatting properties or design features.

The present invention fulfills a method of first, classifying cells contents into different content types which follow: “empty cell”, “text input cell”, “numeric input cell”, “logic cell”, and “formula cell”. Second, more particularly, the method classifying the “formula cell” content type into various subtypes of formula types which follow: “workbook linked formula”, “sheet linked formula”, “cell linked formula”, “sensitivity formula”, “array formula”, “retrieving formula”, “calculative formula”, “computed input formula”, and “input formula”. Further, the method classifying the formula characteristics according to the complexity level of the formula calculation process. The calculation complexity based on the number of functions and operators included within the formulae.

The graphic display of formulae and contents of cells greatly enhances the efficiency of a spreadsheet application or other similar applications, composed of data cells, to a user: It eliminates the need for users to memorize the types of cells formulae; it enables spreadsheet formulae to be clearly viewed all at once; it enables the user to identify both cells values and cells formulae at the same time; it simplifies spreadsheet investigation; it reduces time for users to research a spreadsheet; it enables better analyzing of spreadsheet cells; it prevents user errors; it provides understanding about the complexity of the formulae; it increases confidence in calculations presented in the spreadsheet; and it enables to set up uniform spreadsheet language among different users.

Embodiments of the present invention provides a method for graphically modulating structured data, in a spreadsheet application, comprises a process of defining the reference range for the graphical modulation, applied graphical modulation to all empty cells, applied graphical modulation to all cells with textual input, applied graphical modulation to all cells with numerical input, applied graphical modulation to all cells with logical content, a process of evaluating the formula of each of the cells that contain formulae in order to assigning each of the cells with one or more formula types, applied graphical display to each of the cells according to its formula types, a process of evaluating the formula of each of the cells that contain formulae in order to assigning each of the cells with a formula calculation complexity level, and applied graphical display to each of the cells according to its formula calculation complexity level.

These and other features and improvements, which characterize the present invention, will be apparent from reading the following detailed disclosure of embodiments and a review of the associated drawing. It is to be understood that both the foregoing general description and the following detailed disclosure of embodiments are exemplary and explanatory only and are not restrictive of the invention as claimed.

### DESCRIPTION OF THE DRAWINGS

The present invention will be understood and appreciated more comprehensively from the following detailed description taken in conjunction with the appended drawings in which:

FIG. 1 is a high-level flowchart diagram of an embodiment of the method of the present invention.

While the invention is susceptible to various modifications and alternative forms, specific embodiments thereof have been shown merely by way of example in the drawings. The drawings are not necessarily complete and components are not essentially to scale; emphasis instead being placed upon clearly illustrating the principles underlying the present invention.

### DETAILED DISCLOSURE OF EMBODIMENTS

Generally described, embodiments of the present invention provide the ability to graphically modulating structured data, in a spreadsheet application and other applications, by applying any kind of cell formatting properties or design features to a given cell. Graphical modulation is determined based mainly on formula types and characteristics but also determined based on content types of each of the cells in a given range of cells. Formula types include, but are not limited to the following formula types, “workbook linked formula”, “sheet linked formula”, “cell linked formula”, “sensitivity formula”, “array formula”, “retrieving formula”, “calculative formula”, “computed input formula”, and “input formula”. Formula characteristics include, but are not limited to the following formula characteristics, “formula operators” and “formula functions”. Content types include, but are not limited to the following content types, “empty cell”, “text input cell”, “numeric input cell”, “logic cell”, and “formula cell”.

Illustrative embodiments of the present invention are described more fully below. This invention may be embodied in many different forms and should not be construed as limited to the embodiments set forth herein. In the interest of clarity, not all features of actual implementation are described in this specification. Rather, these embodiments are provided so that this disclosure will be thorough and complete and will fully convey the scope of the invention to those skilled in the art. It will of course be appreciated that in the development of any such actual embodiment, numerous implementation-specific decisions must be made to achieve the developers' specific goals, such as compliance with technology- or business-related constraints, which may vary from one implementation to another. Moreover, it will be appreciated that the effort of such a development might be complex and time-consuming, but would nevertheless be a routine undertaking for those of ordinary skill in the art having the benefit of this disclosure.

The present invention may be described in the general context of computer-executable instructions, such as program modules, executed by one or more computers or other devices. Generally, program modules may include routines, programs, components, data structures, and other types of structures that perform particular tasks or implement particular abstract data types. Moreover, embodiments may be practiced with other computer system configurations, including hand-held devices, multiprocessor systems, microprocessor-based or programmable consumer electronics, minicomputers, mainframe computers, and so forth. The invention described herein may be provided as part of a stand-alone system or in conjunction with a network-based system in which embodiments may also be practiced in distributed computing environments where tasks are performed by other computing devices that are linked through a communications network. In a distributed computing environment, program modules may be located in both local and remote memory storage devices.

Embodiments may be implemented as a computer process or method (e.g. in hardware or in software), a computing system, or as an article of manufacture, such as a computer program product or computer readable media. The computer program product may be a computer storage media readable by a computer system and encoded with a computer program of instructions for executing a process on computing device. The computer program product may also be a propagated signal on a carrier readable by a computing system and subsequently stored on a computer readable medium on computing device. The computing device may include at least one processing unit, and memory.

In embodiments of the present invention, an electronic spreadsheet application or spreadsheet is a software application that can store data, make computations against data, and display data in various visualizations forms. A spreadsheet as referred to herein includes any number of individual spreadsheet files. An individual spreadsheet file hereinafter referred to as workbook. A single workbook typically comprises a collection of worksheets that make up the workbook. A spreadsheet cell, otherwise also a cell, allocated in one worksheet, is capable of referencing another spreadsheet cell or cells or structured name, as described in paragraph [0023] below, allocated in the same or other worksheet, whether within the same workbook or in different workbook.

A range as referred to herein contain any number of cells, includes, an array of cells, a table, a column, a row, or one or more cells, as well as any combination thereof. A structured name as referred to herein may refer to a range or a data includes one or more of a list, a table, a field, a member, or a dimension.

A used range as referred to herein includes any number of cells, allocated in one worksheet, typically comprises a collection of cells in a square structured, within the limits of the range between the rows of the first row containing used cell and the last row containing used cell, and between the columns of the first column containing used cell and the last column containing used cell.

A specified range as referred to herein contain any range, as prescribed in paragraph [0023] supra, or any number of cells, allocated in one worksheet. A specified range may contain range of cells that are within the used range and/or not within the used range (i.e. outside the used range). The specified range is predefined herein for the below-specified process of graphical modulation.

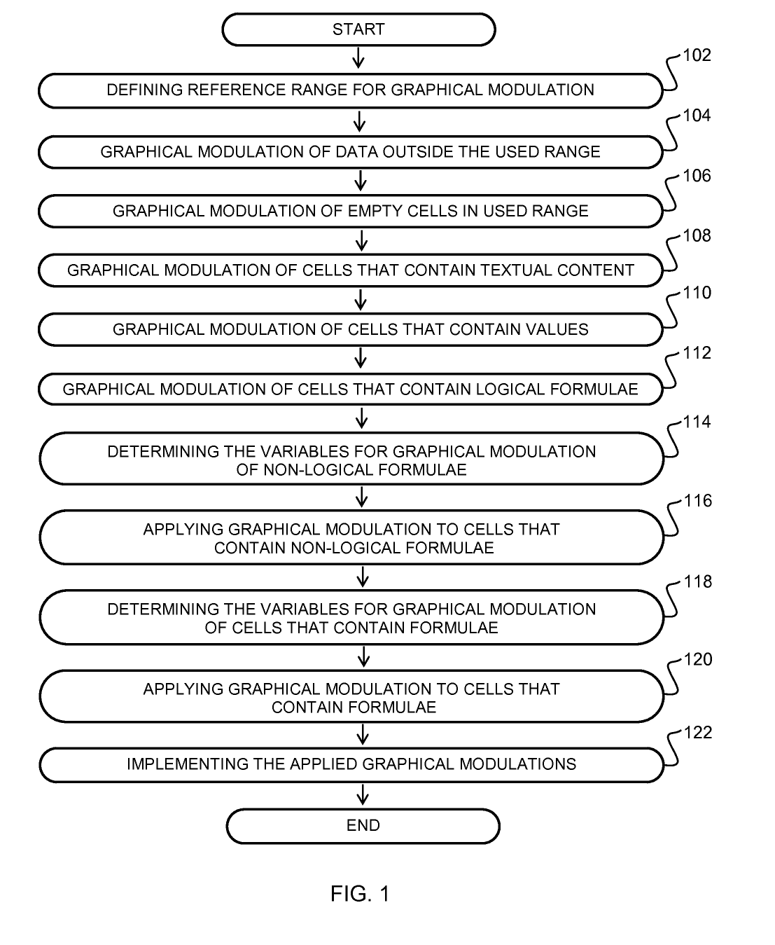

In accordance with some embodiments of the present invent, reference is now made to FIG. 1, showing a high-level flowchart diagram of the method of the present invention. The method depicted in FIG. 1 commences at step 102, with the process of defining the reference range for the graphical modulation of structured data, preferably allocated within a spreadsheet.

The process of defining the reference range for the graphical modulation of structured data, performed at step 102, typically includes constructing the active workbook reference lists (i.e. the first active workbook reference list and the second active workbook reference list), which are lists of workbooks referenced in a cell in the active workbook, associated with the action of graphical modulation. The process of defining the reference range for the graphical modulation of structured data, performed at step 102, typically further includes constructing another active workbook reference list (i.e. the third active workbook reference list), which is a list of worksheets in the active workbook, associated with the action of graphical modulation.

On the implementation description level, the process of defining the reference range for the graphical modulation of structured data, performed at step 102, in a non-limiting manner includes a sequential step, of inputting into the first active workbook reference list the names of workbooks, referenced in at least one cell in the active workbook.

On the implementation description level, the process of defining the reference range for the graphical modulation of structured data, performed at step 102, in a non-limiting manner comprises at least one of the following steps. A sequential step, of inputting into the second active workbook reference list the names of workbooks, listed in the first active workbook reference list. A conditional step, performed for each workbook name in the second active workbook reference list, comprises leaving the name of a given workbook in the second active workbook reference list, if the workbook is open and/or if any structured name is defined therefor. A conditional step, performed for each workbook name in the respective second active workbook reference list, comprises removing the name of the workbook from the second active workbook reference list if the workbook is not open and/or if any structured name is not defined therefor.

Alternatively or additionally, on the implementation description level, the process of defining the reference range for the graphical modulation of structured data, performed at step 102, includes a conditional step of adding the name of the active workbook to the respective second active workbook reference list if any structured name is defined for the workbook therein.

Alternatively or additionally, on the implementation description level, the process of defining an reference range for the graphical modulation of structured data, performed at step 102, includes a sequential step of rearranging the names of the workbooks in the first active workbook reference list, according to the number of characters in the name, in a descending order, from the name comprising the largest number of characters and to the name comprising the fewest number of characters.

Alternatively or additionally, on the implementation description level, the process of defining an reference range for the graphical modulation of structured data, performed at step 102, includes a sequential step of rearranging the names of the workbooks in the second active workbook reference list, according to the number of characters in the name, in a descending order, from the name comprising the largest number of characters and to the name comprising the fewest number of characters.

Alternatively or additionally, on the implementation description level, the process of defining an reference range for the graphical modulation of structured data, performed at step 102, includes a sequential step of inputting into the third active workbook reference list the names of all the worksheets in the active workbook.

Alternatively or additionally, on the implementation description level, the process of defining an reference range for the graphical modulation of structured data, performed at step 102, includes an iterative step of rearranging the names of the worksheets in the third active workbook reference list, according to the number of characters in the name, in a descending order, from the name comprising the largest number of characters and to the name comprising the fewest number of characters, performed after the aforementioned sequential step of inputting into the third active workbook reference list the names of all the worksheets in the active workbook.

Subsequently to the completion of the process of defining the reference range for the graphical modulation of structured data, performed at step 102, all the cells that are within the specified range and not within the used range are subjected to a graphical modulation of the first type, at step 104. Applying graphical modulation of the first type namely also used for defining the cell content as an “empty cell”.

Graphical modulation first type, as referred to herein, inter alia comprises altering any formatting characteristics of the cells includes, but not limited to, font colour, font size, font style (bold, italic, underline, etc.), font typeface, cell fill (colour, effects, pattern, shading), number format, borders (line style, colour), alignment, cell style, in-cell data bar, in-cell icon, and conditional formatting. Altering any formatting characteristics of the cells further includes the prescribed in paragraphs [0037] to [0039] below.

Graphical modulation first type, as referred to herein, inter alia comprises altering the font of the cells. Altering the font of the cells in a non-limiting manner comprises altering the at least one selected from the group consisting of: font type, font size, font colour, font style and font alignment, as well as any combination thereof.

Graphical modulation first type, as referred to herein, inter alia comprises altering the background of the cells. Altering the background of the cells in a non-limiting manner comprises altering the at least one selected from the group consisting of: background type (e.g. gradient, texture, etc.), background colour, background style (e.g. transparency, visibility, etc.), as well as any combination thereof.

Graphical modulation first type, as referred to herein, inter alia comprises altering the borders of the cells. Altering the borders of the cells in a non-limiting manner comprises altering the at least one selected from the group consisting of: borders type, borders thickness, borders colour, borders font and alike, as well as any combination thereof.

The parameters of a choice for graphical modulation of the first type, performed at step 104, on the cells that are within the specified range and not within the used range, may be conferring to the cells that are within the specified range and not within the used range a grayed-out or plane appearance. For instance the parameters of a choice for graphical modulation of the first type, performed at step 104, may be setting: the invisible borders type or borders thickness equaling to 0 (zero), gray background colour, 50 percent background transparency and white font colour. Optionally the parameters for graphical modulation of the first type, performed at step 104, on the cells that are within the specified range and not within the used range, are the very same parameters of a non-modulated cell, namely no apparent alteration of the graphical characteristics of the cells is, performed at step 104, on the cells that are within the specified range and not within the used range.

Subsequently to the graphical modulation of the first type, performed at step 104, graphical modulation second type is optionally applied to all empty cells within the used range, during step 106. On the implementation description level, the process of graphical modulation for used range cells, performed at step 106, in a non-limiting manner includes the sequential step of altering at least one parameter, as set forth in paragraphs [0036] to [0039] supra, in the context of graphical modulation of the first type. The parameters of a choice for graphical modulation of the second type can be distinctively different, similar or identical to the parameters of graphical modulation of the first type, inert alia, as set forth in paragraph [0040] supra. Applying graphical modulation of the second type namely can also be used for defining the cell content as an “empty cell”.

Subsequently to the graphical modulation of the second type, performed at step 106, alternatively or additionally, graphical modulation third type is applied, to all cells with textual content in the used range, at step 108. On the implementation description level, applying graphical modulation third type includes the sequential step of selecting all the cells with textual content and applying graphical modulation of the third type thereto. If a preference is set for distinguishing cells with basic Latin 26-characters alphabet characters subset, as defined by International Organization for Standardization (ISO), the applying graphical modulation of the third type, includes conditional step of applying graphical modulation of the third type and first subtype to all cells with content other than the basic Latin 26-characters alphabet characters subset. Respectively if a preference is set for distinguishing cells with basic Latin 26-characters alphabet characters subset, as defined by ISO, the applying graphical modulation of the third type, includes the conditional step of applying graphical modulation of the third type and second subtype to all cells which contain merely basic Latin 26-characters alphabet characters subset. Graphical modulation of the third type and first subtype preferably comprises a combination of at least one distinct and at least one similar/identical parameter to graphical modulation of third type and second subtype, for instance similar/identical backgrounds and different fonts. It should be acknowledged that the basic Latin 26-characters alphabet characters subset is merely an example of characters subset and any subset or subsets of characters are optionally predefined for the above-specified operation.

If no preference for distinguishing different textual subsets is set, the process of graphical modulation for all cells with textual content in the specified range, performed at step 108, includes the sequential step of applying a uniform graphical modulation of the third type to all cells with textual content in the specified range, which is preferably distinct from the graphical modulation of the first or second types. Applying graphical modulation of the third type namely also used for defining the cell content as a “text input cell”.

Subsequently to the graphical modulation of the third type, performed at step 108, alternatively or additionally, graphical modulation of the fourth type is applied, to all cells in the specified range that contain numerical values, or error values or logical values (i.e. Boolean value of TRUE or FALSE), at step 110. On the implementation description level, the process of graphical modulation of value containing cells in the specified range, performed at step 110, includes the sequential step of applying a distinct graphical modulation of the fourth type and second subtype to all the cells that contain error values. On the implementation description level, the process of graphical modulation of value containing cells in the specified range, performed at step 110, further includes the sequential step of applying a distinct graphical modulation of the fourth type and third subtype to all the cells that contain logical values. Applying graphical modulation of the fourth type namely also used for defining the cell content as a “numeric input cell”. Applying graphical modulation of the fourth type and third subtype namely also used for defining the cell content as a “logic cell”.

Subsequently to the graphical modulation of the fourth type, performed at step 110, alternatively or additionally, graphical modulation of the fifth type is applied, at step 112, to all cells in the specified range that contain logical formulae, namely formulae that return the Boolean values of TRUE or FALSE. On the implementation description level, if a preference is set for distinguishing the cells with logical formulae that return TRUE values, the process of applying graphical modulation of the fifth type to logical formulae containing cells in the specified range, performed at step 112, includes the conditional step of applying graphical modulation of the fifth type and first subtype to all cells which return TRUE values. Respectively if such a preference is set, the process of applying graphical modulation of the fifth type to logical formulae containing cells, performed at step 112, includes the conditional step of applying graphical modulation of the fifth type and second subtype to all cells which return FALSE values. Graphical modulation of the fifth type and first subtype preferably comprises a combination of at least one distinct and at least one similar/identical parameter to graphical modulation of fifth type and second subtype, for instance similar/identical backgrounds and different font colours (e.g. green and red).

If no preference for distinguishing logical formulae which return different values is set, on the implementation description level, the process of applying graphical modulation of the fifth type to logical formulae containing cells in the specified range, performed at step 112, includes the sequential step of applying to all cells in the specified range containing logical formulae a uniform graphical modulation of the fifth type, which is preferably distinct from the graphical modulation of the first to fourth types. Applying graphical modulation of the fifth type namely also used for defining the cell content as a “logic cell”.

Subsequently to the graphical modulation of the fifth type, performed at step 112, variables for graphical modulation of the sixth type and subtypes thereof are determined, at step 114, for all cells in the specified range that contain non-logical formulae, which return numerical and/or textual values. Determining variables for graphical modulation of the sixth type and/or subtypes thereof namely also used for defining the cell content as a “formula cell”. On the implementation description level, alternatively or additionally, the process of determining the variables of graphical modulation of the sixth type and subtypes thereof, for formulae containing cells in the specified range, performed at step 114, includes the conditional step of setting the variable of “array-formula” to TRUE, if a cell contains a formula enclosed in curly brackets “{ }”, otherwise known as braces, in accordance with what is standardized in ISO/IEC IS 29500:2008 for Office Open XML and Microsoft spreadsheet products and/or in ISO/IEC 26300 for OpenDocument format products. If a cell does not contain a formula enclosed in curly brackets, set the variable of “array-formula” to FALSE. Setting the variable of “array-formula” to TRUE namely also used for defining the cell formula as an “array formula”.

Alternatively or additionally, on the implementation description level, the process of determining the variables of graphical modulation of the sixth type and subtypes thereof, for formulae containing cells in the specified range, performed at step 114, includes the sequential step of isolating and determining the variable “formula syntax” to each given cell. The sequential step of isolating and determining the “formula syntax”, in a non-limiting manner includes:
1. Inputting into the variable “formula syntax” the syntax of a formula in a given cell;
2. removing from the “formula syntax” any curly brackets;
3. removing from the “formula syntax” a sequence of calculative operator signs, such as plus “+” or “−”, and/or space characters “_” that follows the first character in the “formula syntax”;
4. removing from the “formula syntax” the first character, if the first character is the equal sign “=”;
5. removing from the “formula syntax” any unnecessary wording or text, namely removing any expression enclosed in inverted commas “expression”.

Alternatively or additionally, on the implementation description level, the process of determining the variables of graphical modulation of the sixth type and subtypes thereof, for formulae containing cells in the specified range, performed at step 114, includes the sequential step of removing from the “formula syntax” any syntax of pathways or linkage to workbooks. If the “formula syntax” of a given cell changes upon removal the syntax of pathways or linkage to workbooks, set the variable of “workbook-linked” to TRUE. If the “formula syntax” of a given cell does not change upon removal the syntax of pathways or linkage to workbooks, set the variable of “workbook-linked” to FALSE. Setting the variable of “workbook-linked” to TRUE namely used for defining the cell formula as a “workbook linked formula”.

Alternatively or additionally, on the implementation description level, the process of determining the variables of graphical modulation of the sixth type and subtypes thereof, for formulae containing cells in the specified range, performed at step 114, includes the sequential step of removing from the “formula syntax” the names of workbooks, listed in the second active workbook reference list, as determined during step 102, with the syntax of structured names following them. If the “formula syntax” of a given cell changes upon removal from the syntax the names of workbooks, listed in the second active workbook reference list, as determined during step 102, with the syntax of structured names following them, set the variable of “workbook-linked” to TRUE. If the “formula syntax” “of a given cell does not change upon removal from the syntax the names of workbooks, listed in the second active workbook reference list, as determined during step 102, with the syntax of structured names following them, set the variable of “workbook-linked” to FALSE.

Alternatively or additionally, on the implementation description level, the process of determining the variables of graphical modulation of the sixth type and subtypes thereof, for formulae containing cells in the specified range, performed at step 114, includes the sequential step of removing from the “formula syntax” the names of workbooks, listed in the first active workbook reference list, as determined during step 102, with the syntax of worksheets names following them. If the “formula syntax” of a given cell changes upon removal from the syntax the names of workbooks, listed in the first active workbook reference list, as determined during step 102, with the syntax of worksheets names following them, set the variable of “workbook-linked” to TRUE. If the “formula syntax” of a given cell does not change upon removal from the syntax the names of workbooks, listed in the first active workbook reference list, as determined during step 102, with the syntax of worksheets names following them, set the variable of “workbook-linked” to FALSE.

Alternatively or additionally, on the implementation description level, the process of determining the variables of graphical modulation of the sixth type and subtypes thereof, for formulae containing cells in the specified range, performed at step 114, includes the sequential step of removing from the “formula syntax” the names of worksheets, listed in the third active workbook reference list, as determined during step 102, typically excluding the name of the active worksheet. If the “formula syntax” of a given cell changes upon removal from the syntax the names of worksheets, listed in the third active workbook reference list, as determined during step 102, set the variable of “sheet-linked” to TRUE. If the “formula syntax” of a given cell does not change upon removal from the syntax the names of worksheets, listed in the third active workbook reference list, as determined during step 102, set the variable of “sheet-linked” to FALSE. Setting the variable of “sheet-linked” to TRUE namely used for defining the cell formula as a “sheet linked formula”.

Alternatively or additionally, on the implementation description level, the process of determining the variables of graphical modulation of the sixth type and subtypes thereof, for formulae containing cells in the specified range, performed at step 114, includes the sequential step of removing from the “formula syntax” any space characters “_”. On the implementation description level, the process of determining the variables of graphical modulation of the sixth type and subtypes thereof, for formulae containing cells in the specified range, performed at step 118, in referring to paragraphs [0063] to [0064] below, further includes the sequential step of isolating and determining the variable “second formula syntax”. The sequential step of isolating and determining the “second formula syntax” of a given cell, in a non-limiting manner includes Inputting into the variable “second formula syntax” the syntax of the variable “formula syntax”. Determining the variable of “second formula syntax” namely used for graphical modulation of the seventh type and subtypes thereof, performed at step 118, in paragraphs [0063] to [0064] below.

Alternatively or additionally, on the implementation description level, the process of determining the variables of graphical modulation of the sixth type and subtypes thereof, for formulae containing cells in the specified range, performed at step 114, includes the sequential step of removing from the “formula syntax” any syntax of any retrieving functions, includes within the application functions database, with an open (left) parenthesis following them. The application functions database, as referred to herein, stores all the functions names text string. Retrieving functions, as referred to herein relates to quasi-calculative functions (i.e. semi-calculative functions), which retrieve a cell value from a data structure, such as lookup table, rather than a true computation or input/output or linkage operation. Examples of retrieving functions include various LOOKUP functions and TRANSPOSE function, as well as DGET function and/or cube functions. If the “formula syntax” of a given cell changes upon removal from the “formula syntax” the syntax of retrieving functions with an open (left) parenthesis following them, set the variable of “retrieving-formula” to TRUE. If the “formula syntax” of a given cell does not change upon removal from the “formula syntax” the syntax of retrieving functions with an open (left) parenthesis following them, set the variable of “retrieving-formula” to FALSE. Setting the variable of “retrieving-formula” to TRUE namely used for defining the cell formula as a “retrieving formula”.

Alternatively or additionally, on the implementation description level, the process of determining the variables of graphical modulation of the sixth type and subtypes thereof, for formulae containing cells in the specified range, performed at step 114, includes the sequential step of removing from the “formula syntax” any syntax of any sensitivity functions (e.g. TABLE function), includes within the application functions database, with an open (left) parenthesis following them. If the “formula syntax” of a given cell changes upon removal from the “formula syntax” the syntax of sensitivity functions with an open (left) parenthesis following them, set the variable of “sensitivity-formula” to TRUE. If the “formula syntax” of a given cell does not change upon removal from the “formula syntax” the syntax of sensitivity functions with an open (left) parenthesis following them, set the variable of “sensitivity-formula” to FALSE. Setting the variable of “sensitivity-formula” to TRUE namely used for defining the cell formula as a “sensitivity formula”.

Alternatively or additionally, on the implementation description level, the process of determining the variables of graphical modulation of the sixth type and subtypes thereof, for formulae containing cells in the specified range, performed at step 114, includes the sequential step of removing from the “formula syntax” all the components as prescribed supra, paragraphs [0048] to [0055], and if after removing all the aforesaid components, there is present in the “formula syntax”, of a given cell, a syntax of any known functions (i.e. any built-in application function or user-defined function includes within the application functions database) with an open (left) parenthesis following them and/or calculative operator sign (e.g. +, −, x, ÷, ̂, √, % or & sign) and/or comparative operator sign (e.g. =, >, ≧, <, ≦, ≠), set the variable of “calculative-formula” to TRUE. If after removing all the aforesaid components, there is no syntax of any known functions with an open (left) parenthesis following them and/or calculative operator sign and/or comparative operator sign, present in the “formula syntax”, of a given cell, set the variable of “calculative-formula” to FALSE. Setting the variable of “calculative-formula” to TRUE namely used for defining the cell formula as a “calculative formula”.

Alternatively or additionally, on the implementation description level, the process of determining the variables of graphical modulation of the sixth type and subtypes thereof, for formulae containing cells in the specified range, performed at step 114, includes the sequential step of removing from the “formula syntax” all the components as prescribed supra, paragraphs [0048] to [0055], and determining whether after removing all the aforesaid components, there is present in the “formula syntax”, of a given cell, at least one character other than numbers 0 to 9 and/or point sign “.” and/or parentheses sign “( )”, set the variable of “non-input-formula” to TRUE. If after removing all the aforesaid components, there is no characters other than numbers 0 to 9 and/or point sign “.” and/or parentheses sign “( )”, present in the “formula syntax”, of a given cell, set the variable of “non-input-formula” to FALSE. Setting the variable of “non-input-formula” to FALSE namely used for defining the cell formula as an “input formula”.

Alternatively or additionally, on the implementation description level, the process of determining the variables of graphical modulation of the sixth type and subtypes thereof, for formulae containing cells in the specified range, performed at step 114, includes the sequential step of removing from the “formula syntax” all the components as prescribed supra, paragraphs [0048] to [0055], and determining whether after removing all the aforesaid components, there is present in the “formula syntax”, of a given cell, at least one characters other than calculative operator sign and/or comparative operator sign and/or numbers 0 to 9 and/or point sign “.” and/or parentheses sign “( )”, set the variable of “non-computed-input-formula” to TRUE. If after removing all the aforesaid components, there are no characters other than calculative operator sign and/or comparative operator sign and/or numbers 0 to 9 and/or point sign “.” and/or parentheses sign “( )”, present in the “formula syntax”, of a given cell, set the variable of “non-computed-input-formula” to FALSE. Setting the variable of “non-computed-input-formula” to FALSE namely used for defining the cell formula as a “computed input formula”.

Alternatively or additionally, on the implementation description level, the process of determining the variables of graphical modulation of the sixth type and subtypes thereof, for formulae containing cells in the specified range, performed at step 114, includes the sequential step of removing from the “formula syntax” all the components as prescribed supra, paragraphs [0048] to [0058], and determining whether after removing all the aforesaid components, the “formula syntax”, of a given cell, has changed and/or at least one of the variables “array-formula”, “workbook-linked”, “sheet-linked”, “sensitivity-formula” or “calculative-formula” was set to TRUE, and/or at least one of the variables “non-input-formula” or “non-computed-input-formula” was set to FALSE, set the variable of “link” to FALSE. If after removing all the aforesaid components, the “formula syntax”, of a given cell, has not changed and/or all of the variables “array-formula”, “workbook-linked”, “sheet-linked”, “sensitivity-formula” and “calculative-formula” were set to FALSE, and/or all of the variables “non-input-formula” and “non-computed-input-formula” were set to TRUE, performed a plurality of conditional operative steps of determining the formula subtype, of the sixth type, comprises the following steps. A conditional step, of determining whether there is not present in the “formula syntax” any structured name, set the variable of “link” to TRUE. If there is present in the “formula syntax” a structured name performed the next conditional step. A conditional step, of determining whether the structured name refer to a range or a data allocated within a different workbook, set the variable of “workbook-linked” to TRUE. If the structured name refer to a range or a data allocated not within a different workbook performed the next conditional step. A conditional step, of determining whether the structured name refer to a range or a data allocated within the active workbook and also the structured name refer to a range or a data allocated not within the active worksheet, set the variable of “sheet-linked” to TRUE. If the structured name refer to a range or a data allocated not within the active workbook or the structured name refer to a range or a data allocated within the active worksheet, set the variable of “link” to TRUE. Setting the variable of “link” to TRUE namely used for defining the cell formula as a “cell linked formula”.

Upon completing the process of determining the variables for graphical modulation of the sixth type and subtypes thereof, for formulae containing cells in the specified range, performed at step 114, graphical modulation/s of the sixth type and/or subtypes thereof is/are applied to formulae containing cells in the specified range, at step 116. On the implementation description level, the process of applying graphical modulation/s of the sixth type and/or subtypes thereof to formulae containing cells in the specified range, performed at step 116, includes a plurality of sequential and conditional operative steps of applying graphical modulation of the sixth type and the different formula subtypes, to any cell in the specified range, as described in paragraph [0061] below, for which during step 114, as described hereinabove, paragraphs [0047] to [0059] supra, at least one of the variables “array-formula”, “workbook-linked”, “sheet-linked”, “sensitivity-formula”, “calculative-formula” and/or “link” was set to TRUE, and/or at least one of the variables “non-input-formula” and/or “non-computed-input-formula” was set to FALSE.

The plurality of sequential and conditional operative steps of applying graphical modulation of the sixth type and the different formula subtypes, to any cell in the specified range, comprises the following steps. A sequential step, of defining specific formatting characteristics, of graphical modulation, from the parameters of a choice, to each formula subtype, of the sixth type. A sequential step, of processing the parameters of a choice for constructing the “subtypes priority list”, which is a list of subtypes conditional levels, comprising any number of levels each includes an equation of a formula subtype variable equal TRUE or FALSE. A conditional step, performed for any given cell formula subtypes variables, of the sixth type, determining whether the condition in any level, of the levels in the subtypes priority list, is TRUE for the given cell, in a descending order, from the highest (first) level and to the lowest (last) level, until the condition in a specific level is TRUE, set to the formatting characteristics of the given cell according to the specific formatting characteristics of the formula subtype in the specific level. For instance the parameters of a choice for constructing the subtypes priority list, may be setting: first “sensitivity-formula” equal TRUE, next “array-formula” equal TRUE, next “non-computed-input-formula” equal FALSE, next “non-input-formula” equal FALSE, next “calculative-formula” equal TRUE, next “workbook-linked” equal TRUE, next “sheet-linked” equal TRUE and next “link” equal TRUE. In an example of determining formatting characteristics for a given cell according to the cell formula subtypes, of the sixth type, some formula subtypes variables setting may be identical to the subtypes priority list shown above: “array-formula” equal TRUE and “sensitivity-formula” equal TRUE. In this example the formatting characteristics of the given cell is set according to the specific formatting characteristics of the first identical subtype, in the subtypes priority list, which is the “sensitivity-formula” subtype. In another example of determining formatting characteristics for a given cell according to the cell formula subtypes, of the sixth type, some variables setting may be identical to the subtypes priority list shown above: “non-computed-input-formula” equal FALSE and “calculative-formula” equal TRUE. In this example the formatting characteristics of the given cell is set according to the specific formatting characteristics of the first identical subtype, in the subtypes priority list, which is the “non-computed-input-formula” subtype. Alternatively to the conditional step described above in this paragraph, replace the following step. A conditional step, performed for any given cell formula subtypes variables, of the sixth type, determining whether the condition in any level, of the levels in the subtypes priority list, is TRUE for the given cell, in a descending order, from the highest (first) level and to the lowest (last) level, if a condition of any specific level is TRUE, set to the formatting characteristics of the given cell according to the specific formatting characteristics of all of the formula subtype in the specific levels determined as TRUE, If a conflicting formatting characteristics has determined by two or more formula subtypes, the formatting characteristics to applied is the formatting characteristics of the highest level in the subtypes priority list from all the levels determined as TRUE.

Graphical modulations of various subtypes, of the sixth type, includes the sequential step of altering at least one formatting parameter, as set forth in paragraphs [0036] to [0039] supra, in the context of graphical modulation of the first type. The parameters of a choice for graphical modulation of various subtypes, of the sixth type, can be distinctively different, similar or identical to the parameters of graphical modulation of the first type, inert alia, as set forth in paragraph [0040] supra. Additionally, the parameters of a choice for graphical modulation of various subtypes, of the sixth type, can be distinctively different, similar or identical to the parameters of graphical modulation of the second type, and/or third type, and/or fourth type, and/or fifth type, and subtypes thereof, inert alia, as set forth in paragraphs [0041] to [0046] supra. It is noted that in some embodiments the graphical modulation of the fifth type is a subtype of the graphical modulation of the sixth type, and logical formulae are respectively assigned with variables determined during step 114. Optionally the parameters for graphical modulation of the cells, within the specified range, whether within the used range or outside the used range, are the very same parameters of a non-modulated cell, namely no apparent alteration of the graphical characteristics of the cells is performed.

Subsequently to the graphical modulations of various subtypes, of the sixth type, performed at step 116, variables for graphical modulation of the seventh type and subtypes thereof are determined, at step 118, for all cells in the specified range that contain formulae. On the implementation description level, alternatively or additionally, the process of determining the variables of graphical modulation of the seventh type and subtypes thereof, for formulae containing cells in the specified range, performed at step 118, includes the sequential step of determining the variable “formula operators”. The sequential step of determining the “formula operators”, of a given cell, includes inputting into the variable “formula operators” the counting amount of all of the single, non-sequence, operator signs, such as single plus “+” or minus “−”, and/or all of the sequences of operator signs (i.e. a sequence of two or more characters), such as “>=” or “+−−”, present in the “second formula syntax”, as determined in paragraph [0053] supra.

Alternatively or additionally, on the implementation description level, the process of determining the variables of graphical modulation of the seventh type and subtypes thereof, for formulae containing cells in the specified range, performed at step 118, includes the sequential step of determining the variable “formula functions”. The sequential step of determining the variable “formula functions”, of a given cell, includes inputting into the variable “formula functions” the counting amount of all of the known functions syntax (i.e. any built-in application function or user-defined function includes within the application functions database) with an open (left) parenthesis following them, present in the “second formula syntax”.

Upon completing the process of determining the variables for graphical modulation of the seventh type and subtypes thereof, for formulae containing cells in the specified range, performed at step 118, graphical modulation/s of the seventh type and/or subtypes thereof is/are applied to formulae containing cells in the specified range, at step 120. On the implementation description level, the process of applying graphical modulation/s of the seventh type and/or subtypes thereof to formulae containing cells in the specified range, performed at step 120, includes a plurality of sequential and conditional operative steps of applying graphical modulation of the seventh type and the different formula subtypes, to any cell in the specified range, as described in paragraph [0066] below, for which during step 118, as described hereinabove, paragraphs [0063] to [0064] supra, at least one of the variables “formula operators” and/or “formula functions” was set to a number greater than 0 (zero).

The plurality of sequential and conditional operative steps of applying graphical modulation of the seventh type and the different formula subtypes, to any cell in the specified range, comprises the following steps. A sequential step, of defining discrete and/or continuous formatting characteristics, of graphical modulation, from the parameters of a choice, to each formula subtype, of the seventh type. A sequential step, of processing the parameters of a choice, to each formula subtype, for constructing the “subtypes levels list”, which is a list comprising any number of levels, each level includes: a greater number, from 0 (zero) to the maximum number, from the parameters of a choice; and, discrete formatting characteristics to each level for constructing increasing levels of formatting characteristics, which have discrete and/or continuous formatting characteristics in between the levels. A conditional step, performed for any given cell formula subtype variable (“formula operators” or “formula functions”), of the seventh type, determining whether the number in any level, of the levels in the subtypes levels list, is greater from the formula subtype variable, for the given cell, in an ascending order, from the lowest (first) level and to the highest (last) level, until the number in a specific level is greater from the formula subtype variable, set to the formatting characteristics of the given cell according to the specific formatting characteristics of the previous level to the specific level, or set to the formatting characteristics of the given cell according to a relative formatting characteristics between the formatting characteristics in the previous level and to the formatting characteristics in the specific level, proportionately to the distance between the numbers of the two levels.

Graphical modulations of various subtypes, of the seventh type, includes the sequential step of altering at least one formatting parameter, as set forth in paragraphs [0036] to [0039] supra, in the context of graphical modulation of the first type. The parameters of a choice for graphical modulation of various subtypes, of the seventh type, can be distinctively different, similar or identical to the parameters of graphical modulation of the first type, inert alia, as set forth in paragraph [0040] supra. Additionally, the parameters of a choice for graphical modulation of various subtypes, of the seventh type, can be distinctively different, similar or identical to the parameters of graphical modulation of the second type, and/or third type, and/or fourth type, and/or fifth type, and/or sixth type, and subtypes thereof, inert alia, as set forth in paragraphs [0041] to [0046], and in paragraphs [0061] to [0062] supra. Optionally the parameters for graphical modulation of the cells, within the specified range, whether within the used range or outside the used range, are the very same parameters of a non-modulated cell, namely no apparent alteration of the graphical characteristics of the cells is performed.

Subsequently to the graphical modulations of the first to seventh types, and subtypes thereof, performed at steps 104 to 120, alternatively or additionally, applying graphical modulations of the first to seventh types, and subtypes thereof, are implemented, at step 122, for all cells in the specified range. On the implementation description level, the process of applying graphical modulation of the first to seventh types and subtypes thereof, for cells in the specified range, performed at step 122, includes the sequential step of implementing the altering of any cell formatting characteristics, on a given cell, by conditional formatting. Alternatively, On the implementation description level, the process of applying graphical modulation of the first to seventh types and subtypes thereof, for cells in the specified range, performed at step 122, includes the sequential step of implementing the altering of any cell formatting characteristics on a transparent surface display, visible above the cells surface, for any given cell, in the form of layers, each layer display the cells formatting characteristics, for one or more of the first to seventh types, and subtypes thereof. Each layer from the surface display, visible above the cells surface, for any given cell, can be presented or not, according to the parameters of a choice for graphical modulation.

It will be appreciated by those skilled in the art that the present invention is not limited by what has been particularly shown and described hereinabove. Rather the scope of the invention is defined by the claims which follow. Those skilled in the art may make modifications, particularly in light of the foregoing teachings. For example, in various embodiments, similar operations can include more or fewer steps than those shown in this specification. Moreover, in other embodiments, similar operations can include the steps of the operations shown in this specification in different orders. In another example, those skilled in the art will see that although the cells described throughout are associated with electronic spreadsheet application, other types of applications which display structured data or data in tabular format or data cells may take advantage of certain embodiments, including database applications, word processing applications, data reporting tools, and so forth.

What is claimed is:

1. A computer implemented method for graphically modulating structured data in a spreadsheet, comprising:
receiving a reference of a range of spreadsheet cells, wherein each cell of the reference of range of spreadsheet cells include a respective cell formula;
receiving a collection of formula characteristics definitions;
receiving a collection of formula characteristics formats to format the reference of range of spreadsheet cells, wherein formatting includes:
identifying the respective formula characteristics for each cell formula in the reference of range of spreadsheet cells, and
for each respective formula characteristic, applying into the cells of each respective formula characteristic, a respective cell format determined from a correlation of each respective formula characteristic to the respective cell format in the collection of varying cell formats.

2. The computer implemented method of claim 1, wherein the collection of formula characteristics definitions includes at least one of the following formula types:
“sensitivity formula”; or
“array formula”; or
“retrieving formula”; or
“computed input formula”, and “input formula”; or
“workbook linked formula”, and “sheet linked formula”, and “cell linked formula”.

3. The computer implemented method of claim 1, wherein the collection of formula characteristics definitions includes at least one of the following formula characteristics:
the number of functions includes within the formula; or
the number of operators includes within the formula.

4. A system for graphically modulating structured data in a spreadsheet, comprising:
receiving a reference of a range of spreadsheet cells, wherein each cell of the reference of range of spreadsheet cells include a respective cell formula;
receiving a collection of formula characteristics definitions;
receiving a collection of formula characteristics formats to format the reference of range of spreadsheet cells, wherein formatting includes:
identifying the respective formula characteristics for each cell formula in the reference of range of spreadsheet cells, and
for each respective formula characteristic, applying into the cells of each respective formula characteristic, a respective cell format determined from a correlation of each respective formula characteristic to the respective cell format in the collection of varying cell formats.

5. The computer implemented method of claim 4, wherein the collection of formula characteristics definitions includes at least one of the following formula types:
“sensitivity formula”; or
“array formula”; or
“retrieving formula”; or
“computed input formula”, and “input formula”; or
“workbook linked formula”, and “sheet linked formula”, and “cell linked formula”.

6. The computer implemented method of claim 4, wherein the collection of formula characteristics definitions includes at least one of the following formula characteristics:
the number of functions includes within the formula; or
the number of operators includes within the formula.

7. A computer implemented method for graphically modulating structured data in a spreadsheet, comprising:
receiving a reference of a range of spreadsheet cells, wherein each cell of the reference of range of spreadsheet cells include a respective cell content and/or formula;
receiving a surface display, presented above the surface of a reference of a range of spreadsheet cells, includes different layers;
receiving a collection of cell contents and/or formula characteristics definitions for each respective layer, in the respective surface display;
receiving a collection of cell contents and/or formula characteristics formats to format the surface display, presented above the surface of a reference of range of spreadsheet cells, wherein formatting includes:
identifying the respective cell contents and/or formula characteristics for each cell in the reference of range of spreadsheet cells, and
for each respective cell content and/or formula characteristic, applying into the surface display, presented above the surface of a reference of a range of spreadsheet cells, in different layers, a respective cell format determined from a correlation of each respective cell content and/or formula characteristic to the respective cell format in the collection of varying cell formats.
